(19) United States
(12) Patent Application Publication
(10) Pub. No.: US 2007/0217769 A1
(43) Pub. Date: Sep. 20, 2007

(54) METHOD AND KIT FOR CONDUCTING MARKETING RESEARCH USING DVD TECHNOLOGY

(75) Inventors: Christian Super, Cincinnati, OH (US); Michael D. Larson, Wilton, CT (US); Robert John Soullier, Fairfield, OH (US); James Bird, West Chester, OH (US)

Correspondence Address: ANDERSON, KILL & OLICK, P.C., 1251 AVENUE OF THE AMERICAS, NEW YORK,, NY, 10020-1182, US

(73) Assignee: IPSOS ASI, INC.

(21) Appl. No.: 11/734,992

(22) Filed: Apr. 13, 2007

Related U.S. Application Data
(63) Continuation-in-part of application No. 10/723,821, filed on Nov. 24, 2003.

(51) Int. Cl. H04N 5/00

(52) U.S. Cl. 386/126

(57) ABSTRACT

A method and a kit for conducting marketing research in which respondents evaluate a program and commercials using DVD technology.

### RELATED APPLICATIONS

The present disclosure is a continuation in part of pending patent application Ser. No. 10/723,821 filed Nov. 24, 2003 and claims priority thereof under 35 U.S.C. 120.

### BACKGROUND OF THE INVENTION

1. Field of the Invention

The present invention relates to a method and kit for conducting marketing research. In particular, the present invention relates to a method and a kit for conducting marketing and advertising research in which respondents evaluate a program and commercials using DVD technology.

2. The Prior Art

Marketing research tools such as surveys are known in the art. U.S. Pat. No. 4,891,712 relates a method of conducting marketing research using a video tape.

This methodology requires that the tape be erased after it is played. Further, this invention does not permit the tape to be played out of order. It would be desirable to provide a marketing tool with greater flexibility and where the program is not destroyed so that follow-up questions can be asked.

### SUMMARY OF THE INVENTION

The present invention provides a method and a kit for conducting marketing research using DVD technology in which respondents are recruited to participate in market research evaluation of a program and enter a prize drawing. A package is sent to each respondent who agrees to participate. Each package includes a DVD containing a program and commercials to be evaluated and code numbers to access said program and said commercials on said DVD, said package further including instructions for respondents to read and prize drawing books to fill out by respondents. Secured codes are entered by said respondents for accessing said DVD in order to view said program and said commercials in said DVD in one sitting.

### BRIEF DESCRIPTION OF THE DRAWINGS

FIG. 1 is a flow chart of a first embodiment of the present disclosure;

FIG. 2 is a flow chart illustrating the operation of the DVD in accordance with the first embodiment of the present disclosure of FIG. 1;

FIG. 3 is a flow chart of a second embodiment of the present disclosure; and

FIG. 4 is a flow chart illustrating the operation of the DVD in accordance with the second embodiment of the present disclosure of FIG. 1.

### DETAILED DESCRIPTION OF THE PREFERRED EMBODIMENTS

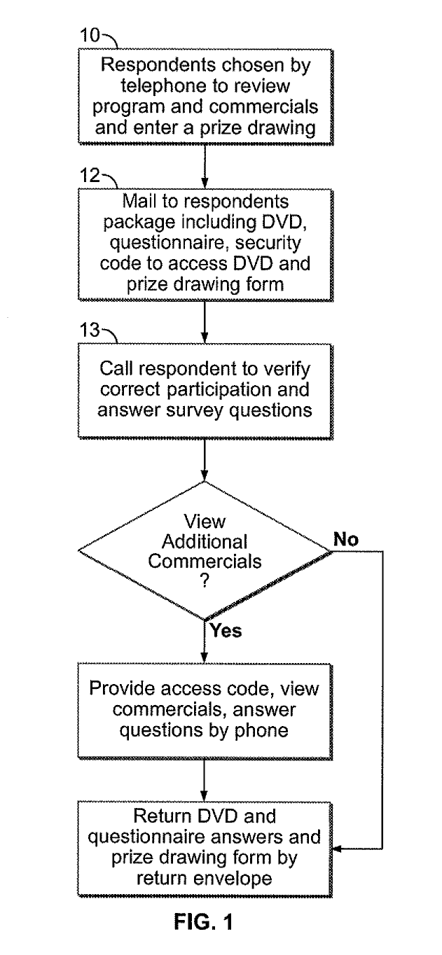

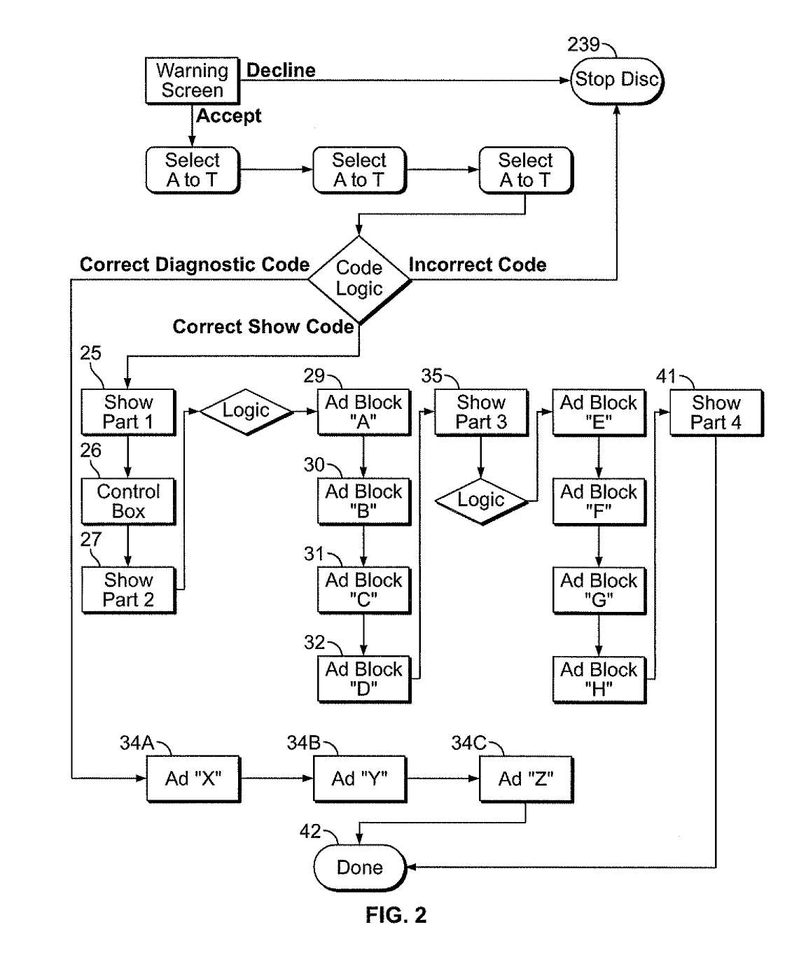

Referring to the drawings of FIGS. 1 and 2, FIG. 1 illustrates the operation of the present invention. In step 10 of FIG. 1, potential respondents are recruited, preferably by telephone, to evaluate a program such as a television program and commercials and also to enter a prize drawing contest program. Respondents are then sent a package containing a secured DVD that includes a program and commercials (see step 11 of FIG. 1). The package also includes prize drawing books and instructions. Respondents then access the DVD using the specific code supplied for the specific DVD sent and view the program and commercials in one sifting and answer a survey questionnaire included in the package. Respondents then fill out the prize drawing booklet (see step 12).

Each respondent is then called to verify correct participation and to answer survey questions. Such questions would typically include questions about the program viewed, when it was viewed, whether the questionnaire had been filled out, whether the show had been ever seen previously, whether the show was watched in its entirety, and whether the respondent left the room at any time during which the show was being played (step 13).

Respondents are then asked to view additional commercials on the DVD (step 14).

Respondents decide if they will continue participating by viewing these new commercials (step 15).

If respondents agree (step 15), then a new security code is provided to access the new commercials in the DVD. After viewing the commercials, the respondents are asked by telephone questions about these new commercials. The respondents then return the material as indicated in step 16.

If respondents disagree to continue, they return the DVD and written survey answers and prize drawing booklet in the preaddressed and postage paid enclosed envelope (step 16).

The DVD is programmed to be accessed by the security code that is indigenous to accessing the program stored on the DVD for viewing. The program can be replayed, but only from the beginning, and cannot be fast forwarded. This is to ensure that the respondent views it in one sitting in its entirety. Other commercials or other information may be contained on the DVD which requires a different access code as illustrated in step 15 of FIG. 1.

FIG. 2 illustrates the flow path of the DVD's operation. The DVD has a security menu requiring specific codes to view material stored on the DVD as described above. Thus, as shown in FIG. 2, the menu has a warning screen requiring an input of the security code (21). Three code elements, preferably alpha-numerical, are inputted (22a, 22b and 22c). If they are determined to be correct (see 23), then the DVD plays the security code for the initial program and commercials (25) or the additional commercials (26).

If the inputted three lettered alphabetical security code is correct as a show code determined in step 23 of FIG. 2, then the first part of the program (part number 1) is displayed for viewing as indicated in step 25. If the code is incorrect, then the disc is stopped as shown in step 23a. If the inputted code is determined to be a correct diagnostic code in step 23, then advertisements x, y and z (in steps 34a, 34b and 34c, respectively) are displayed in sequence as shown in FIG. 2.

After step 26, where the control ad is displayed and viewed, the viewer next watches part number 2 of the show as indicated in step 27. Then, based on the inputted code, logic step 28 determines whether for that particular code which of ads A, B, C and D from blocks 29, 30, 31, 32, respectively, to display for that particular code. The choice may be one of demographics assigned to certain alphabetical codes so that the preferred demographic group views the advertisements targeted for them. The viewer next watches part number 3 of the show in step 35. Logic in step 36 determines which ads are to be viewed by the viewer based upon his initial inputted three letter alphabetical code from ads E, F, G, and H in steps 37, 38, 39 and 40, respectively. Part number 4 of the show is next viewed in step 41 and the viewing is completed (see step 42).

An additional feature of the present invention is the auto eject feature. In order to ensure that the data in the DVD is not copied for later viewing in violation of the rules for viewing the data for market research purposes, if the DVD is not placed in a regular DVD player but instead put into a PC connected drive, the PC will detect the file labeled autorun.inf. The PC must have Auto Play on at the time, which is the default condition in Windows, so most users will have this turned on.

Once the PC detects the file autorun.inf, the file will start the VB program start.exe. The purpose of the program is to ensure that DVD media, in accordance with survey rules, are only played in a standard DVD player, and not on a PC. This is to prevent copying the data for later viewing, and possibly invalidating the survey results of the present invention.

The program operates as follows: the PC detects the file autorun.inf, which then starts the executable start.exe. This program then causes the DVD (or CD) drive to open. The user is prompted to play the disc in a standard TV-connected DVD player.

A standard DVD player ignores the autorun.inf file and simply plays the DVD as normal.

The program is written in Visual Basic 6, although the invention is not limited to any particular program language.

The files on the target disc include: Start.exe and autorun.inf.

The commented source code and detailed design are described below:
The source files are: Cdopen.vbp; Cdopen.vbw; and Mainopen.form.

The detailed design is as follows:
In distributing test material on DVD, the user MUST play it on a regular DVD player. The user views it on a TV which is NOT on a PC-connected DVD drive. This is to prevent copying the DVD video files for later viewing. Thus, the program causes the disc to eject if the disc is put in a personal computer (PC)-connected drive. The auto play on the client PC must be on. Since this is the default condition in Windows, most users will have this turned on.

Upon reading the disc, the PC detects the file autorun.inf. This file starts the VB program start.exe (the code is listed below).

The PC loops through the available drives to see if it is of type CD-ROM (4). Windows treats a DVD drive just like a CD-ROM drive. If the current drive returns type 4, then the PC checks to see if it is the drive with the disc in it. This is accomplished by checking for the existence of the file start.exe. If it returns NO, then skip and move to the next drive. If YES, then an error is raised which halts processing and turns control over to the error routine.

The Error routine erropendrive then makes available the drive letter to use. This goes in Label2.Caption, The timer attached to this form kicks in, and after the required time (3 seconds), runs the eject. The drive ejects the disc.

Then the form closes and the program halts execution.

A warning is flashed on the screen reading: “Warning This DVD may not be played in a PC-connected drive.” The source code for start.exe indicated below may be inserted into a VisualBasic 6 project, and recompiled as necessary. All the code written for the invention uses sample code freely available at www.microsoft.com, in the MSDN section.

The source code is as follows:

```
    -----------------Begin ***.exe source, with extra comments---------------
    ‘Declare the function to run the mciSendString commands
    Private Declare Function mciSendString Lib “winmm.dll’ Alias
“mciSendStringA” (ByVal lpstrCommand As String,
ByVal lpstrReturnString As String, ByVal uReturnLength As Long,
ByVal hwndCallBack As Long) As Long
    Private Sub Form_Load( )
    Label2.Visible = False
    MainOpen.Show
    Me.Timerl.Enabled = True
    Dim fso, d, dc, s, n
    Dim CurrPath
    Dim progpath
    Dim drivepath
    Dim myFile
    Progpath = ‘\start.exe”
    ‘progpath = “\open\cdo2.exe” ‘used for testing only
    ‘loop through all the drives in turn
    ‘determine whether it is a DriveType of CD/DVD
    if yes, see if the program exists (Start.exe)
    ‘if yes, then run the eject routine
    Set fso = CreateObject(“Scripting.FileSystemObject”)
    Set dc = fso.Drives
    For Each d In dc
    Select Case d.drivetype
    Case Is = 4
    drivepath = d
    CurrPath = drivepath & progpath ’ & Left(d, 1)
    On Error Resume Next
    myFile = Dir(drivepath & progpath)
    Select Case myFile
    Case “start.exe”
    Me.Label2.Caption = d
    On Error GoTo erropendrive
    erroropendrive.Raise
    Case Else
    ‘do nothing
    End Select
    End Select
    Next
    erropendrive:
    MyCurrPath = Label2.Caption ‘what drive to open
    End Sub
    ‘when the timer fires, (4000ms) run this eject sequence
    Private Sub Timerl_Timer( )
    EjectMe
    Unload Me
    End Sub
    ‘first, we must ‘open’ the drive
    ‘then, pop open the door
    ‘then, ‘clean up and close the drive (not the door)
    Private Sub EjectMe( )
    Dim openString
    Dim doorString
    Dim closeString
    openString = “open cdaudio!” & Label2.Caption & “ alias drive ” &
Left(Label2.Caption, 1)
    doorString = “set drive” & Left(Label2.Caption, 1) & “ door open
    wait”
    closeString = “close cdaudio!” & Label2.Caption & “alias drive” &
Left(Label2.Caption, 1)
    mciSendString openString, 0&, 0&, 0&
    mciSendString doorString, 0&, 0&, 0&
    mciSendString closeString, 0&, 0&, 0&
    End Sub
```

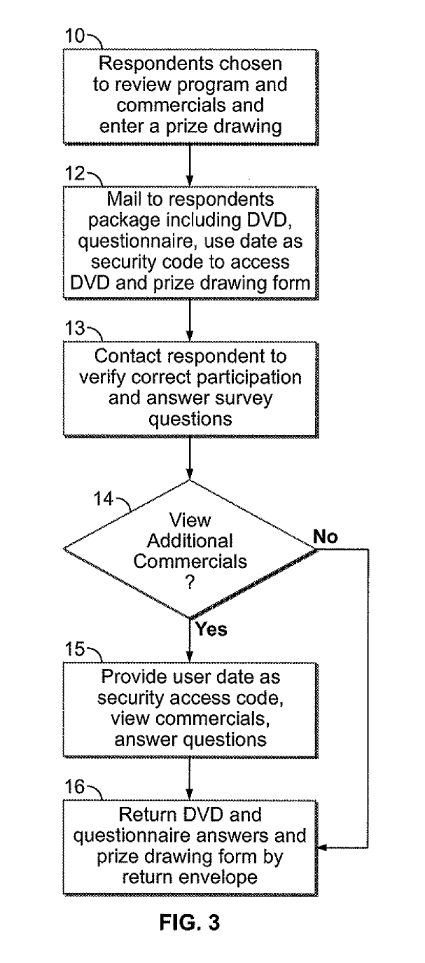

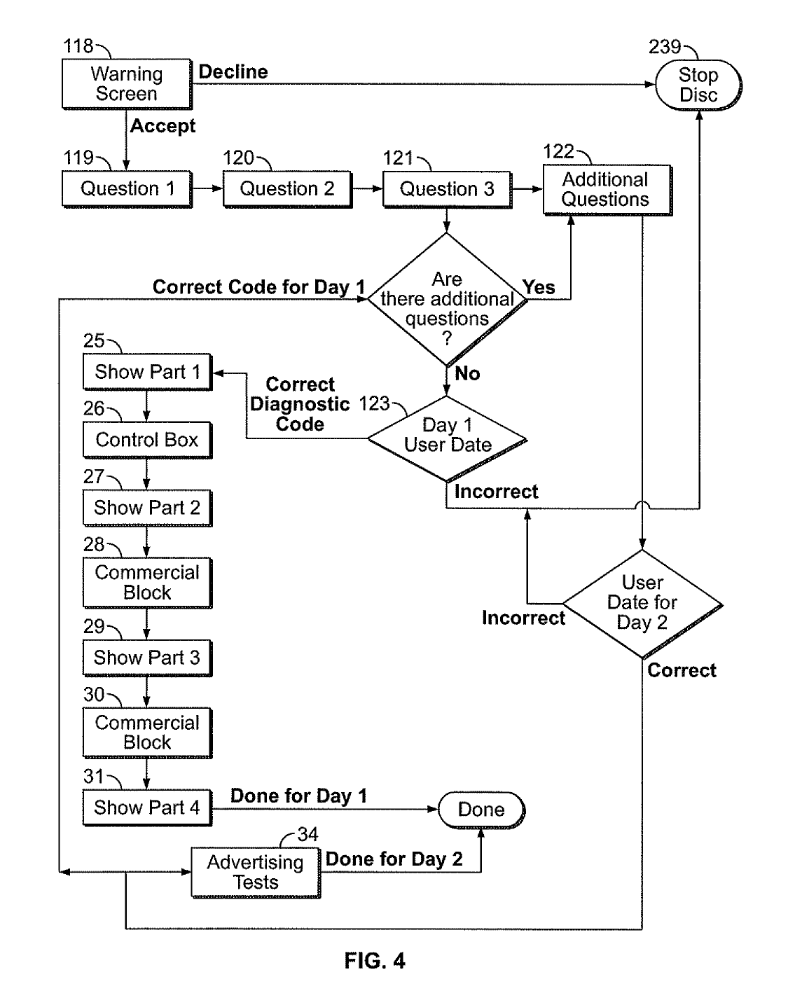

Referring now to the second embodiment of the present disclosure shown in FIGS. 3 and 4, this embodiment is similar to the first embodiment described with regard to FIGS. 1 and 2 with some variations. In particular, instead of a security code for accessing the DVD a use date will be provided to the respondent. In addition visual basics are no longer used for an auto-eject feature as was done for the first embodiment. Also, although the capacity to do so is available, preferably the second embodiment will not identify demographics as was done for the first embodiment.

Another feature of this embodiment of the present disclosure is that to make it difficult for a respondent to use the DVD in a personal computer or laptop and instead must use it in a television set with DVD player capabilities to ensure that the content of the DVD program is viewed as intended and to safeguard against the content of the DVD being copied or downloaded and transmitted via the internet.

Security for DVD player connected to a TV is provided in the following manner by the second embodiment of the present disclosure:
When placed in a set-top/appliance DVD player (a player connected to the TV), respondents will see an FBI warning against piracy, followed by a screen asking for their acceptance to terms of use. The respondent must hit “accept” to continue. If the respondent selects “decline” he/she will be asked to eject the disk and send it back to Ipsos-ASI.
The show contents are secured using various levels of menu authoring to make respondents think it can only be watched one time.
Each show will be authored to be “date enabled.” Respondents toggle on their remote to answer a short series of menu screens:
Screen One—Asks the respondent his/her gender.
Screen Two—Asks how many television sets are owned.
Screen Three—Asks the current month and day, this is the user code that must be input to access the DVD. At least one user code will be provided and preferably two-each for a different portion of the DVD viewing.

On day one, the first user code should be input to view the first day portion of the DVD which is the program such as by way of non-limiting illustrative example a television show program and perhaps embedded commercials for that television show. On day two a second portion of the DVD is viewed such as commercials that are either the same as the embedded commercials in day one of the DVD viewing or different commercials. In order for the respondent to view day 2 contents of the DVD the respondent must input a second use code. The use codes for day one and two are provided and do not have to be the same day that the actual viewing occurs.

Example: If a respondent is instructed to view it on June 1st and enters June 1st, into the menu options, he will successfully view the program. If he tries to watch again a week later, assuming that he must enter June 8th into the menu, the show will not play. Alternatively, this feature may be removed from the present invention.

The DVD is authored so that the respondent cannot scan forward, scan back, skip, and rewind. A respondent can pause the program.

Once they've passed these screens, the show plays and ends automatically after the credits. No refocus ads can be seen.

During the callback interview, refocus ads can be viewed only by using the remote to enter a new month/date code given by the interviewer.

Security for a DVD player connected to a computer is provided as follows:
The DVD was designed to be played in a DVD player connected to a television. However, we realize that content will be viewed in other formats including a computer.
No DVD security is 100% and there will be individuals who can gain access to the content of our disc.
If the DVD is placed into a PC, a series of programming steps have been taken to make the ability to view the files difficult.
All solutions are focused on Windows based PC.

Once the disc is inserted to play, the disc will eject and a browser window will open to be played in a computer. We have the ability to track and report data on website hits.

The video files needed to play the show will be hidden from windows. Once we change the setting, the files cannot be seen. Also, you can copy the files that are on the disc, but the only files that can be seen are the “dummy” files.

The security program will go into the PC registry and change settings so that hidden files cannot be viewed.

If a respondent is able to bypass the initial first play that ejects the disc and hides the files, there will be several alias files that run the program that ejects the disc titled “Read Me,” “Start Here,” etc.

If a respondent makes it into the inner files, there are two video files that need to work in order to play the show correctly. There will be 50-100 alias video files used to confuse individuals who get into the video folder. One other point of interest is that the show and commercial files will be Hi-Res MPEG 2 files. They are not streaming media files and to place an MPEG 2 on a website for download would be impractical because it would be too big. For a respondent to take these files and make them accessible via the web, they would need to first run it through software of some kind and then transcode them to a smaller file such as .wmv. This is “doable” but not by the average person.

The software used to hide the video files” on a personal computer or a lap top operates as follows:

When a disc master is created, the video folder is marked as “hidden”. Then, when a user places the DVD in their PC (not MAC/this is for PC only) one uses an active X control that is created using C++ to go into the personal computer (PC) registry and mark the setting that says “do not show hidden files”. The same program then reboots the PC, as this is necessary for the registry setting change to apply.

The second embodiment of the present disclosure can use a custom application to mark the video folder as hidden, but that is part of its automated process and probably not pertinent, as the same task could be created either through automation or manual.

Further, if a person tries to play the DVD in a personal computer or a laptop connected via the internet, a message will be displayed warning the user and the disc is ejected from the computer and the computer is rebooted. Each attempt is logged on a central web server.

Referring to FIG. 3, in step 10 of FIG. 3, respondents are chosen to review a program such as a television show and commercials and permitted to enter a prize drawing contest. A package is then mailed to respondents. The package includes a DVD containing the program and commercials, a questionnaire and a prize drawing form (step 12).

As indicated in step 13, after the respondent enters the user code, preferably first user date, and views the program and any embedded commercials within the program, the respondent is contacted to verify respondent's participation and have the respondent answer survey questions about the program and the embedded commercials and any other questions believed to be pertinent.

In step 14 of FIG. 1, for example, by way of non-limiting illustrative example, a second day of viewing the DVD contents where, for example, additional commercials or the embedded commercial without the television program can be viewed by the respondent by preferably inputting a second use date. The respondent is then contacted preferably by telephone and asked questions. In step 15 of FIG. 3, a DVD, questionnaire answers and prize drawing forms are sent back in the return envelope provided to the respondent. As shown in steps 13 and 15, if no additional commercials or commercials that were embedded in the day one viewing are intended to be viewed without the television program, then step 15 is followed with those materials, questionnaire answers and prize drawing form sent back in the return envelope.

FIG. 4 illustrates the flow path of the DVD's operation. Thus, as shown in FIG. 4, the menu has a warning screen. If the respondent hits “accept”, then a first screen appears asking the respondent his/her gender. After that question is answered, a second screen appears asking the respondent how many television sets are owned. After that question is answered, a third screen for security purposes asks the respondent for a user date which can be the current month and day. This user date and perhaps another user date for viewing a later portion of the DVD contents is provided with the materials in the packet sent to the respondent. The DVD has a menu requiring at least one and preferably two user dates to view material stored on the DVD as described above requiring an input of the at least one and preferably first user date (121). If the user date is determined to be correct (see 123), then the DVD plays the program to be viewed for that user date. A second user date can be input at another time perhaps the next day to view additional commercials (126). If the user date is not correct the disk will be stopped, step 239. Additional questions may be asked of the respondent during step 22 of FIG. 4.

If the inputted first user date is correct then the first part of the program (part number 1) is displayed for viewing as indicated in step 25. If the user date is incorrect, then the disc plays an infinite still frame and is stopped as shown in step 239.

After step 126, where the control ad is displayed and viewed, the viewer next watches part number 2 of the show as indicated in step 127. Then, the viewer watches the contents of the DVD as indicated in steps 129, 130 and 131. If additional commercials or the commercials that were embedded in the show viewed during day are to be watched, then a second user date is required (see steps 124, 123 and 134).

Thus, the DVD is protected by hiding video files of the DVD by adjusting preferences on said Personal computer (PC) or said laptop computer by coding on said DVD. In addition, the DVD has coding to generate and transmit a message to a shipper of said DVD when said DVD is inserted into said personal computer or said laptop alerting said shipper of said insertion.

Those skilled in the art will appreciate that various adoptions and modifications of the just described preferred embodiment can be configured without departing from the scope and spirit of the invention. Therefore, it is to be understood that within the scope of the appended claims, the invention may be practiced other than as specifically described herein.

1. A method of conducting marketing research using DVD technology, the steps comprising:
recruiting respondents to participate in market research evaluation of a program and entering a prize drawing;
sending a package to each of the recruited respondents, said package including a DVD containing a program and commercials to be evaluated and at least one user date to access said program and said commercials on said DVD, said package further including instructions for respondents to read and prize drawing books to filled out by said respondents;
viewing said program in said DVD by accessing said DVD with said at least one user date by said respondent in one sitting;
calling each said respondent to verify said program was viewed correctly and to ask survey questions to each said respondent;
filling out program evaluations by said respondent; and
mailing back said DVD and filled out prize books.

2. The method according to claim 1, wherein said at least one user date includes a first user date for viewing a program and on said DVD.

3. The method according to claim 2, wherein said program includes a television show.

4. The method according to claim 4, wherein said program includes said television show and commercials embedded within said television show.

5. The method according to claim 1, wherein said at least one user date includes a second user date is two user dates includes a second user date supplied with said package for said respondent to view additional information said DVD and asking each said respondent about said new information after said viewing

6. The method according to claim 5, wherein said new information is additional commercials

7. The method according to claim 5, wherein said program includes said television show and commercials embedded within said television show and said additional information are said commercials embedded within said television program.

8. The method according to claim 1, wherein said DVD is protected from having its contents being viewed, copied or downloaded or transmitted by internet if played on a Personal computer (PC) or a lap top computer.

9. The method according to claim 8, wherein said DVD is protected by hiding video files of the DVD by adjusting preferences on said Personal computer (PC) or said lap top computer by coding on said DVD.

10. The method according to claim 8, wherein said DVD has coding to log each attempt on a central server of said DVD when said DVD is inserted into said personal computer or said lap top alerting said shipper of said insertion.

11. A kit for conducting marketing research using DVD technology, comprising:
a solicitation program of respondents for participation in market research evaluation of a program and entering a prize drawing, said solicitation program including recruiting said respondents for participation by telephone;
a package sent to each of the recruited respondents, said package including a DVD containing a program and commercials to be evaluated and at least one user date to access said program and said commercials on said DVD, said package further including instructions for respondents to read and prize drawing books to filled out by said respondents;
said program in said DVD being viewed by accessing said DVD with said at least one user date by said respondent in one sitting;
each said respondent being contacted to verify said program was viewed correctly and to ask survey questions to each said respondent;
program evaluations to be filled out by each said respondent; and
a return envelope for mailing back said DVD and filled out prize books.

12. The kit according to claim 11, wherein said at least one user date includes a first user date for viewing a program and on said DVD.

13. The kit according to claim 12, wherein said program includes a television show.

14. The kit according to claim 12, wherein said program includes said television show and commercials embedded within said television show.

15. The kit according to claim 11, wherein said at least one user date includes a second user date is two user dates includes a second user date supplied with said package for said respondent to view additional information said DVD and asking each said respondent about said new information after said viewing.

16. The kit according to claim 15, wherein said new information is additional commercials

17. The kit according to claim 15, wherein said program includes said television show and commercials embedded within said television show and said additional information are said commercials embedded within said television program.

18. The kit according to claim 11, wherein said DVD is protected from having its contents being viewed, copied or downloaded or transmitted by internet if played on a Personal computer (PC) or a lap top computer.

19. The kit according to claim 18, wherein said DVD is protected by hiding video files of the DVD by adjusting preferences on said Personal computer (PC) or said laptop computer by coding on said DVD.

20. The kit according to claim 18, wherein said DVD has coding to log each attempt on a central server of said DVD when said DVD is inserted into said personal computer or said lap top alerting said shipper of said insertion.
